(19) United States
(12) Patent Application Publication
(10) Pub. No.: US 2010/0025265 A1
(43) Pub. Date: Feb. 4, 2010

(54) Potentiometric biosensor and the forming method thereof

(75) Inventors: Shen-Kan Hsiung, TAOYUAN COUNTY (TW); Nien-Hsuan Chou, TAOYUAN COUNTY (TW); Jung-Chuan Chou, TAOYUAN COUNTY (TW); Tai-Ping Sun, TAOYUAN COUNTY (TW)

Correspondence Address: WPAT, PC;INTELLECTUAL PROPERTY ATTORNEYS, 7225 BEVERLY ST., ANNANDALE, VA, 22003, US

(73) Assignee: CHUNG YUAN CHRISTIAN UNIVERSITY, TAOYUAN COUNTY (TW)

(21) Appl. No.: 12/372,915

(22) Filed: Feb. 18, 2009

(30) Foreign Application Priority Data
Aug. 1, 2008 (TW) 097129173

(51) Int. Cl. G01N 27/26

(52) U.S. Cl. 205/792; 204/403.14

(57) ABSTRACT

The present invention discloses a potentiometric biosensor for urea and creatinine detection, and the forming method thereof. The disclosed biosensor comprises a substrate, at least two working electrode on the substrate, at least one reference electrode on the substrate, an internal reference electrode on the substrate, and a packaging structure which separates the adjacent electrodes. The working electrode comprises urease or creatinine iminohydrolase (CIH). The detection signal is transmitted for further processing through a wire or an exposed surface on the biosensor. The disclosed biosensor is replaceable.

### BACKGROUND OF THE INVENTION

1. Field of the Invention

The present invention is generally related to biosensors and the fabrication method thereof, and more particularly a potentiometric biosensor for detection of creatinine and urea.

2. Description of the Prior Art

Biosensor is commonly defined as an analytical device which combines energy converter with immobilized biomolecules for detecting specific chemicals via the interaction between biomolecules and such specific chemicals. The above-mentioned energy converter can be a potentiometer, a galvanometer, an optical fiber, a surface plasma resonance, a field-effect transistor, a piezoelectric quartz crystal, a surface acoustic wave, and so on. The field-effect transistor used to fabricate the miniaturized device via mature semiconductor process has become an important technique for the current market trend of developing light and portable products.

A model of a biosensor is based on an analytic method of detecting a organic compound. The analytic method was established using the specificity theory of an enzyme and its substrate. This specificity theory is proposed by Clark et al. in 1962 [Clark L. C., C. Lyois, “Electrode system for continuous monitoring in cardiovascular surgery”, Annals of the New York Academy of Sciences, vol. 102, pp. 29-33, 1962.). According to the Intechno Cunsulting investigation reports, [Zhang Chen-Sui, market demand and technology-developing tendency of sensors, Industrial Economics & Knowledge Center, 2002.], biotechnology combining with a semiconductor technology and reducing device size will have the advantages of small volumes, small weight, high reliability, high precision, good performance, low cost, and mass production.

U.S. Pat. No. 5,804,047 [Isao Karube, Susan Anne Clark, Ryohei Nagata, “Enzyme-immobilized electrode, composition for preparation of the same and electrically conductive enzyme”, 1998.] discloses an enzyme sensing system suitable for detecting a specific substance. A electrode immobilized the enzyme can immobilize a mixture which comprises a conductive enzyme and other conductive material formed by using covalent bonds to connect the enzyme and the electron transport substance, and the ways to immobilize a enzyme onto a base material are screen printing, and brushing.

U.S. Pat. No. 5,945,343 [Christiane Munkholm, “Fluorescent polymeric sensor for the detection of urea”, 1999.] discloses a fluorescent polymeric sensor for the detection of urea. The fluorescent polymeric sensor comprises three layers. The first layer is a protonated pH sensitive fluorophore immobilized on a hydrophobic polymer. The second layer is composed of urease and a polymer; and the third layer is a polymer. The structure of the sensor disclosed in the invention is simple and the sensor can be fabricated as a miniaturized and disposable device. Without improvement of the operation stability and the production of the optical sensor, the major disadvantage of the invention is high cost, as compared to voltage-mode and current-mode sensor system.

Although the concentration of urea or creatinine can be measured via spectrum analysis, but the general method is the enzyme method [C. Puig-Lleixa, C. Jimenez, J. Alonso, J. Bartroli, “Polyurethaneacrylate photocurable polymeric membrane for ion-sensitive field effect transistor based urea biosensors”, Analytica Chimica Acta, vol. 389, pp. 179-188, 1999; R. Koncki, I. Walcerz, E. Leszczynska, “Enzymatically modified ion-selective electrodes for flow injection analysis”, Journal of Pharmaceutical and Biomedical Analysis, vol. 19, pp. 633-638, 1999; A. B. Kharitonov, M. Zayats, A. Lichtenstein, E. Katz, I. Willner, “Enzyme monolayer-funtionalized field-effect transistors for biosensor applications”, Sensors and Actuators B, vol. 70, pp. 222-231, 2000.]. At present, the commercial biosensors are based on field-effect transistors and current-mode circuit. The principle of the current-mode technology is to detect a small electric current in organisms. It has fast response, but the output stage circuit needs an additional bias voltage to convert the signals. Therefore, the fabrication of current-mode biosensors is more complicated design and has higher costs. A redox reaction occurs when the current-mode biosensors detect specific chemicals and it produces a small electric current. The current flows through the surface of sensor surface and damages the biological molecules (such as enzymes), and hence affect the follow-up use of enzymes for chemical reaction.

Moreover, the biosensors based on field-effect transistors are mostly produced by the semiconductor manufacturing process that needs strict conditions (such as the need for high vacuum environment, etc.), which results in high costs of production. Since the rise of medical and health consciousness, the combination of biosensors and medical examination has become a trend (such as the measurement of creatinine concentration in human serum). How to make the biosensors having simple structure, good stability, and replaceable with low cost in medical purpose has become the current trend in sensor development.

### SUMMARY OF THE INVENTION

In accordance with the present invention, a potentiometric biosensor for detection of creatinine and urea is provided for commercial need.

The present invention further discloses a potentiometric biosensor for detection of creatinine and urea. The potentiometric biosensor revealed in this invention is for detecting the content of creatinine in serum and urea in urine which are important indicators for the renal, thyroid and muscle function of human body.

The present invention discloses a potentiometric biosensor based on field-effect transistors which can be fabricated to form the miniaturized component via semiconductor process. The potentiometric biosensor of the present invention doesn't need an additional bias voltage to convert the signals. The disclosed biosensor comprises a substrate, at least two working electrode on the substrate, at least one reference electrode on the substrate, an internal reference electrode on the substrate, and a packaging structure which separates the adjacent electrodes. The working electrode comprises urease or creatinine iminohydrolase (CIH). The detection signal is transmitted for further processing through a wire or an exposed surface on the biosensor. The disclosed biosensor is replaceable.

### BRIEF DESCRIPTION OF THE DRAWINGS

FIG. 1 is a schematic diagram of the potentiometric biosensor according to the first embodiment of the present invention;

FIG. 2 is a layer schematic diagram of the potentiometric biosensor according to the example of the first embodiment of the present invention;

FIG. 3 is a schematic diagram of the potentiometric biosensor with a conducting layer according to the example of the first embodiment of the present invention;

FIG. 4A is a schematic diagram of the potentiometric biosensor with a wire according to the example of the first embodiment of the present invention;

FIG. 4B is a schematic diagram of the potentiometric biosensor with an exposed surface according to the example of the first embodiment of the present invention;

FIG. 5 A to E are schematic diagrams of the working electrodes of the potentiometric biosensor according to the example of the first embodiment of the present invention;

FIG. 6 is a schematic diagram of the potentiometric biosensor for detection of creatinine and urea according to the first embodiment of the present invention;

FIG. 7 is a schematic structure circuit diagram of the potentiometric biosensor for detection of creatinine and urea according to the first embodiment of the present invention;

FIG. 8 is a flow chart of the method for handle the potentiometric biosensor for detection of creatinine and urea according to the present invention;

FIG. 9 is a voltage diagram of detection of creatinine with different concentration via the potentiometric biosensor according to the present invention; and

FIG. 10 is a voltage diagram of detection of urea with different concentration via the potentiometric biosensor according to the present invention;

### DESCRIPTION OF THE PREFERRED EMBODIMENTS

What is probed into the invention is a potentiometric biosensor for detection of creatinine and urea. Detail descriptions of the structure and elements will be provided in the following in order to make the invention thoroughly understood. Obviously, the application of the invention is not confined to specific details familiar to those who are skilled in the art. On the other hand, the common structures and elements that are known to everyone are not described in details to avoid unnecessary limits of the invention. Some preferred embodiments of the present invention will now be described in greater detail in the following specification. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

U.S. Pat. No. 5,858,186 [Robert S. Glass, “Urea biosensor for hemodialysis monitoring”, 1999.] discloses an electrochemical sensor for quantitatively detecting the urea concentration of the dialysis waste liquid in the process of blood dialysis. The sensor uses an enzyme to hydrolyze the urea and detects the variation of pH generated by the hydrolysis. The structure of the sensor is good for mass production and reducing production cost, so the structure has an advantage for developing a disposable sensor. For a typical application, this sensor is usually used to diagnose the stop point of the blood dialysis at an inspection center or used with an appropriate computer system. This sensor can also be used at home by a dialysis patient, and only requires a few drop of blood sample to perform detection.

U.S. Pat. No. 4,691,167 [Hendrik H. v. d. Vlekkert, and Nicolaas F. de Rooy, “Apparatus for determining the activity of an ion (pIon) in a liquid”, 1987) discloses an apparatus determining the reactivity of an ion in a liquid. The system comprises a measuring circuit, an ion sensitive field effect transistor (ISFET), a reference electrode, a temperature sensor, amplifiers, a controller, computing circuits, and a memory. Since the sensitivity is a function of temperature and drain current and is decided by a variable of gate voltage, the sensitivity can be obtained by calculating formulas stored in the memory.

U.S. Pat. No. 5,474,660 [Ian Robins, John E. A. Shaw, “Method and apparatus for determining the concentration of ammonium ions in solution”, 1995.] discloses an apparatus and a method thereof for detecting ammonium ion concentration, wherein an ammonia gas sensor is placed into a container, and a solution containing ammonium ions is placed into a partial region of the container; hydroxyl ions are generated from the solution by an electrochemical generator at the vicinity of the container placing the ammonia gas sensor, and then the sensor detects the ammonia gas through a film, transformed by the ammonium ions in the solution. The sensor disclosed by this patent thus using the above-mentioned method to detect the ammonium ion concentration in a solution.

U.S. Pat. No. 6,021,339 [Atsushi Saito, Soichi Saito, Masako Miyazaki, “Urine testing apparatus capable of simply and accurately measuring a partial urine to indicate urinary glucose value of total urine”, 2000.] discloses a uric acid multiple sensor which comprising a sensing device for measuring urea and at least one component for detecting sodium and chlorine ions in uric acid. As far as we know, the specific weight of uric acid is based on the detected signals generated from the concentration of each device. Besides, a component for detecting the units of glucose must be added herein and then finally the particular specific weight in sugar can be used to correct the measured sugar [that is, glucose base line]. After that, after all uric acid secreted 24 hours, the detected conditions can be understood simply and accurately from a partial uric acid.

U.S. Pat. No. 4,970,145 [Hung P. Bennetto, Gerard M. Delaney, Jeremy R. Mason, Chrispother F. Thurston, John L. Stirling, David R. DeKeyzer, “Immobilized enzyme electrodes”, 1990.) discloses an enzyme electrode fabricated using a carbon electrode as a base structure. The enzyme electrode with this structure allows the enzyme [such as glucose oxidized enzyme] attach on the electrode to fabricate an amperometric sensor with good response and stability. The substrate material of the electrode is a thin carbon electrode plated with platinum seldom and can perform detection with the condition that the dissolved oxygen at low level. The enzyme sensor runs measurement in a 10 mM glucose solution, and the reaction result is a current density having several hundreds microampere per square centimeter with a short response time. While preserved under a humid environment at room temperature, the sensor still has a good stability and several months of its working life.

U.S. Pat. No. 5,397,451 [Mitsugi Senda, Katsumi Hamamoto, Hisashi Okuda, “Current-detecting type dry-operative ion-selective electrode”, 1995.] discloses an amperometric and dry-operated ion-selective electrode which comprising a work electrode and an auxiliary electrode, both are fabricated on an insulating substrate. A first layer is a hydrophilic polymer, but the ion-selective membrane using a hydrophobic polymer.

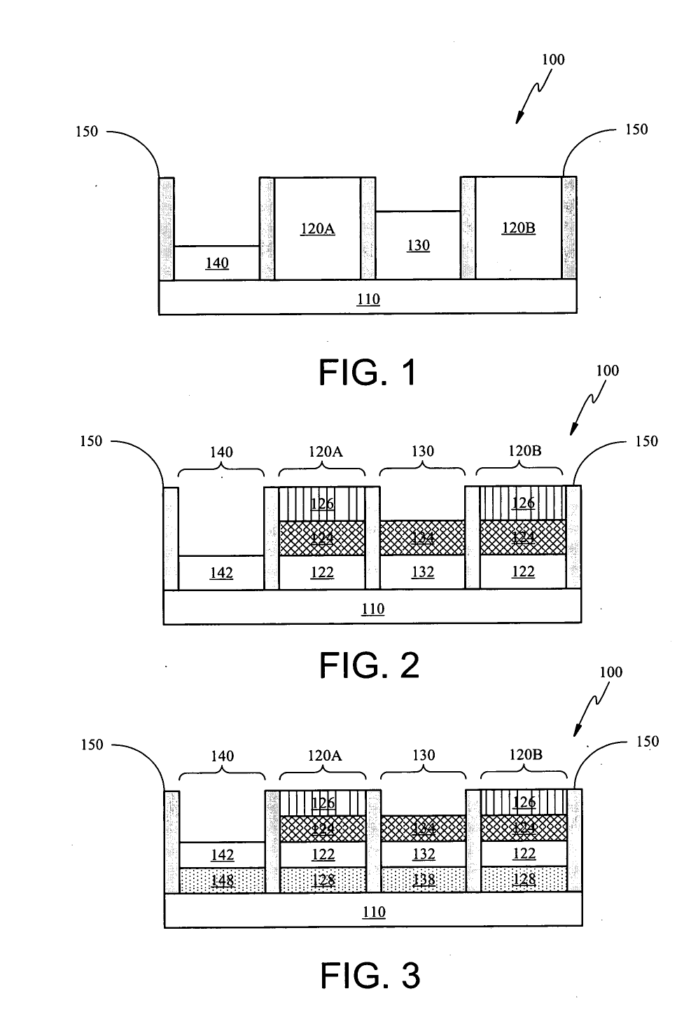

As shown in FIG. 1, a first embodiment of the present invention discloses a potentiometric biosensor 100, comprising a substrate 110, at least two working electrodes (120A; 120B), at least one counter electrode 130, an internal reference electrode 140 formed on the substrate 110, and a packaging structure 150, which separates the adjacent electrodes. The material of above-mentioned substrate 110 comprises one selected from the group consisting of the following: insulating materials [such as insulating glass], non-insulated materials [such as indium-tin oxide glass and non-insulated tin oxide glass] and flexible materials [such as polyethylene terephthalate [PET]]. The above-mentioned packaging structure 150 is epoxy resin. The potentiometric biosensor is used to detect the concentration of urea and creatinine at the same time or detect them separately. The best measurement range of the biosensor 100 is between pH6 to pH8.

As shown in FIG. 2, in this embodiment of the present invention, there are at least two working electrodes (120A; 120B) which respectively comprise a first sensing layer 122 on the substrate 110, a first ion-selective layer 124 on the first sensing layer 122, and a first enzyme layer 126 on the first ion-selective layer 124. The first sensing layer 122 mentioned above is a non-insulated solid state ion which comprises one selected from the group consisting of the following: tin dioxide, titanium dioxide, and titanium nitride. The above-mentioned first ion-selective layer 124 is an ammonium ion-selective layer, comprising carboxylated polyvinylchloride (PVC-COOH). The above-mentioned first enzyme layer 126 comprises creatinine iminohydrolase (CIH) and urease. The first enzyme layer 126 is immobilized on the first ion-selective layer 124 via entrapment method by polyvinyl alcohol containing stilbazolium group (PVA-SbQ). As mentioned above, there are at least two working electrodes (120A; 120B) which comprise enzyme layers 126. Both of the enzyme layers 126 can be made of creatinine iminohydrolase (CIH), or both made of urease, or one is made of iminohydrolase (CIH] and the other is made of urease.

As shown in FIG. 3, it is a first example of the present embodiment. At least two the working electrodes (120A; 120B) further comprise a first conducting layer 128 between the substrate 110 and the first sensing layer 122 for outward transmission of a detection signal. The first conducting layer 128 has low impedance to enhance the transmission efficiency of the detection signal. Moreover, the first conducting layer 128 comprises one selected from the group consisting of the following: copper, carbon, silver, aurum, silver chloride, Indium tin oxides (ITO).

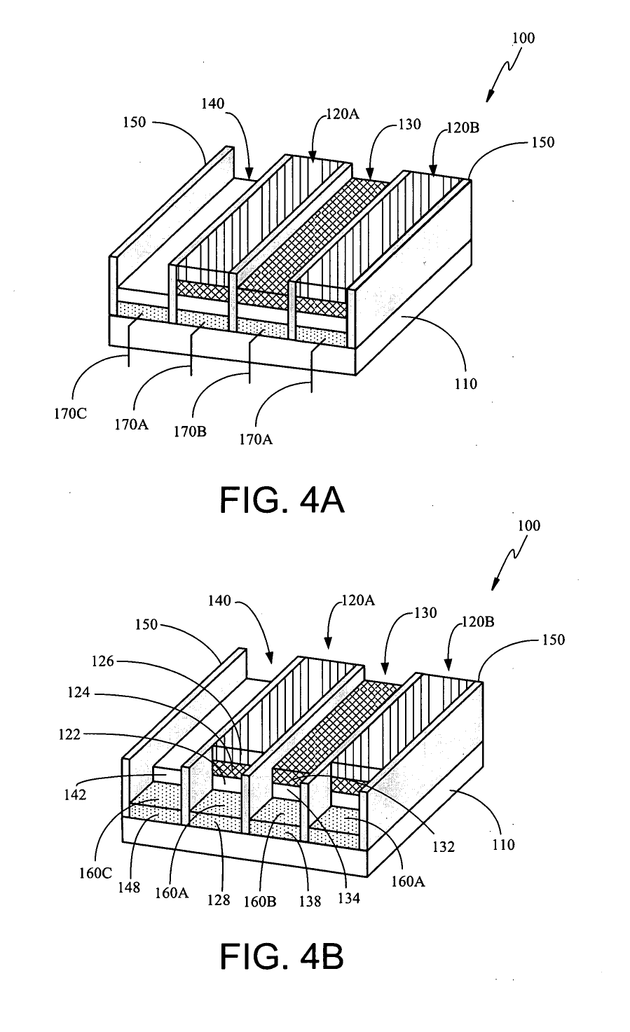

As shown in FIG. 4A, it is a second example of the present embodiment. At least two working electrodes (120A; 120B) further comprise respectively a wire 170A connected to the first conducting layer 128 to transmit the detection signal. The wire 170A comprises one selected from the group consisting of the following: copper, carbon, silver, aurum, silver chloride, Indium tin oxides (ITO). On the other hand, as shown in FIG. 4B, it is a third example of the present embodiment. The first conducting layers 128 of the working electrodes (120A; 120B) respectively comprises an exposed surface 160A to electrically couple with the external environment for outward transmission of the detection signal.

As shown in FIG. 2, in this embodiment of the present invention, the counter electrode 130 is an ammonium ion-selective electrode which comprises a second sensing layer 132 on the substrate 110, and a second ion-selective layer 134 on the second sensing layer 132. As shown in FIG. 3, the counter electrode 130 may further comprises a second conducting layer 138 which is between the substrate 110 and the second sensing layer 132. The second conducting layer 138 has low impedance to enhance the transmission efficiency of the detection signal. Moreover, the second conducting layer 138 comprises one selected from the group consisting of the following: copper, carbon, silver, aurum, silver chloride, Indium tin oxides (ITO). The second sensing layer 132 is a non-insulated solid state ion which comprises one selected from the group consisting of the following: tin dioxide, titanium dioxide, and titanium nitride. The second ion-selective layer 134 is an ammonium ion-selective layer which comprises carboxylated polyvinylchloride (PVC-COOH).

As shown in FIG. 4A, the counter electrode 130 further comprises a wire 170B connected to the second conducting layer 138 to transmit the detection signal. The wire 170B comprises one selected from the group consisting of the following: copper, carbon, silver, aurum, silver chloride, Indium tin oxides (ITO). On the other hand, as shown in FIG. 4B, the second conducting layer 138 comprises an exposed surface 160B to electrically couple with the external environment and for outward transmission of the detection signal.

As shown in FIG. 2, in this embodiment of the present invention, the internal reference electrode 140 is a hydrogen ion-selective electrode, which comprises a third sensing layer 142 on the substrate 110. Moreover, as shown in FIG. 3, the internal reference electrode 140 may further comprises a third conducting layer 148 which is between the substrate 110 and the third sensing layer 142 for outward transmission of a third detection signal, and the third conducting layer 148 has a low impedance to enhance the transmission efficiency of the detection signal. Furthermore, the third conducting layer 148 comprises one selected from the group consisting of the following: copper, carbon, silver, aurum, silver chloride, Indium tin oxides (ITO). The third sensing layer 142 is a non-insulated solid state ion and comprises one selected from the group consisting of the following: tin dioxide, titanium dioxide, and titanium nitride.

As shown in FIG. 4A, the internal reference electrode 140 further comprises a wire 170C connected to the third conducting layer 148 to transmit of the third detection signal, and the wire 170C comprises one selected from the group consisting of the following: copper, carbon, silver, aurum, silver chloride, Indium tin oxides (ITO). On the other hand, as shown in FIG. 4B, the third conducting layer 148 comprises an exposed surface 160C to electrically couple with the external environment and for outward transmission of the detection signal.

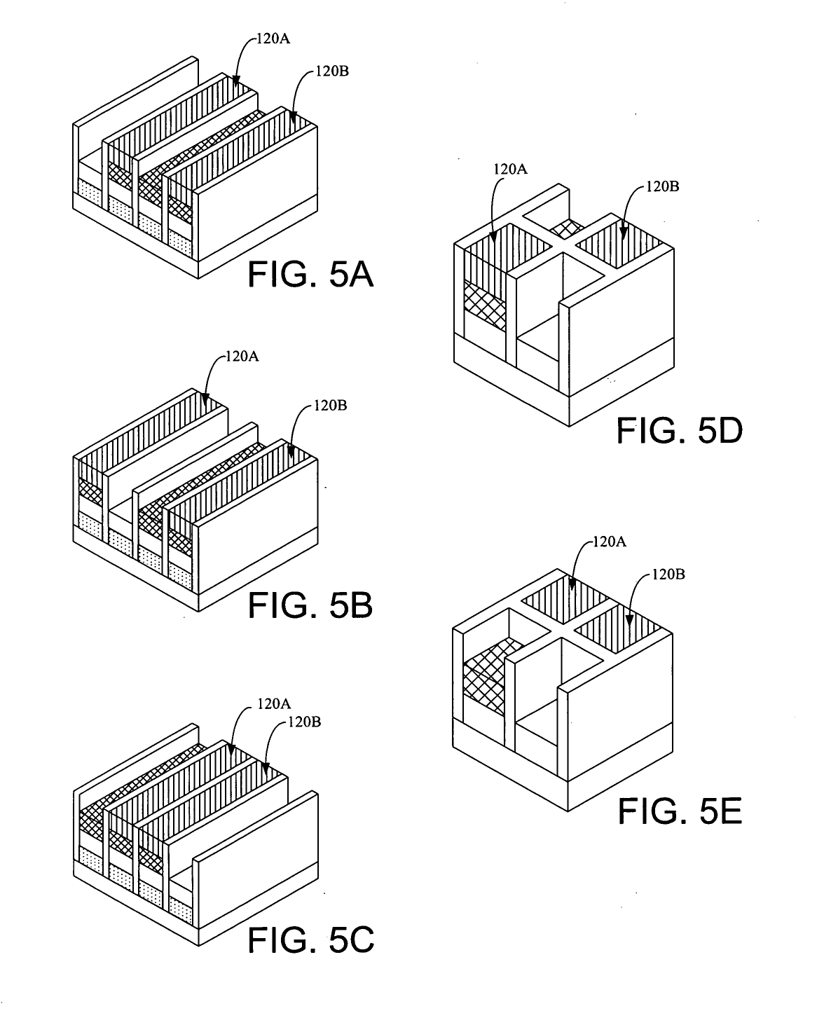

As shown in FIG. 5A, FIG. 5B, and FIG. 5C, these two working electrodes (120A; 120B), counter electrode, and internal reference electrode can be arranged in parallel. These two working electrode (120A; 120B) can be placed at intervals, side by side, both at outside. The present invention includes, but is not restricted to, these arrangements. Referring to FIG. 5D and FIG. 5E, these two working electrodes (120A; 120B) can be arranged in an array. These two working electrode (120A; 120B) can be placed diagonally or side by side.

The present invention discloses a method of forming a potentiometric biosensor. First, provide a substrate, and then form an internal reference electrode on said substrate. Then form at least one counter electrode on said substrate. Then form at least two working electrodes on said substrate. Finally, form a packaging structure to separate the adjacent electrodes. A better method further comprises forming a conducting layer between these electrodes and the substrate and a wire connected to the second conducting layer to facilitate transmission of the detection signal, before the electrodes are formed on the substrate. Another better method further comprises forming an exposed surface on said at least two working electrodes, at least one counter electrode, and internal reference electrode to electrically couple with the external electrical devices and transmits the detection signal.

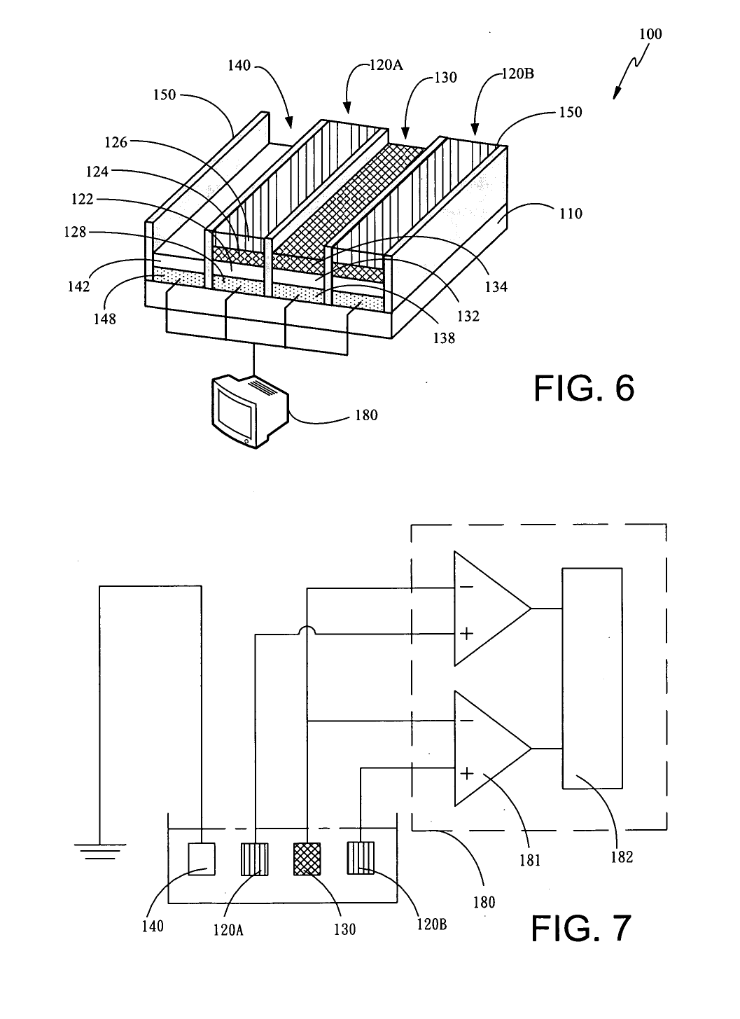

As shown in FIG. 6, a potentiometric biosensor 100 for detection of creatinine and urea, comprising a substrate 110, at least two working electrodes (120A; 120B), at least one counter electrode 130, an internal reference electrode 140 formed on the substrate 110, a packaging structure 150 to separate the above-mentioned four electrodes, and a detection signal readout module 180. The detection signal readout module 180 is electrically coupled with the potentiometric biosensor, and receives the detection signals from the counter electrode 130, the internal reference electrode 130 and the working electrodes (120A; 120B) for calculating the concentration of creatinine or urea.

FIG. 7 shows the structure of the biosensor and readout module which is depicted in FIG. 6. The detection signal readout module 180 comprise at least two instrumental amplifiers 181 and a computing devices 182. The reference voltage of the tested solution is defined via an internal reference electrode 140 connecting to the ground. A working voltage of the sensor is defined via connecting the counter electrode 130 to the negative input of the instrumental amplifiers 181, and connecting the working electrodes (120A; 120B) to the positive input of the instrumental amplifiers 181. The concentration of urea or creatinine is calculated by subtracting the voltage of the ion-selective layer 134 from the voltage of the enzyme sensing layer 126 using the computing devices 182.

The present invention discloses a measuring method using a potentiometric biosensor, comprising: measuring a reference voltage via putting at least two working electrodes into a buffer solution, and measuring the reference voltage. Next, amplify the readout signal of at least two working electrodes using at least two instrumental amplifiers, and measure a reaction voltage via putting at least two working electrodes into the tested solution. These at least two instrumental amplifiers electrically couple with a signal measurement module separately, and the signal measurement module measures the output signals from instrumental amplifiers to produce plural measured values, and each measured value corresponds to each output signal of the instrumental amplifiers.

The present invention discloses a potentiometric biosensor comprising a substrate, at least two working electrodes on the substrate, at least one reference electrode on the substrate, an internal reference electrode on the substrate, and a packaging structure which separates the above-mentioned at least four electrodes. The substrate comprises one selected from the group consisting of the following: insulating glass, non-insulated indium-tin oxide glass, non-insulated tin dioxide glass, and polyethylene terephthalate (PET). About the condition of forming an internal reference electrode, please refer to the condition of forming a tin dioxide/indium-tin oxide/glass-extension ion biosensor or a tin dioxide/carbon/PET-extension ion biosensor presented as follows. About the condition of forming a counter electrode, please refer to the condition of forming ammonium ion-selective electrode presented as follows. About the condition of forming at least two working electrodes, please refer to the condition of forming a potentiometric urea sensing film and a potentiometric creatinine sensing film presented as follows.

(A) The condition of forming a tin dioxide/indium-tin oxide/glass-extension ion biosensor:

(1) an Indium-tin oxide glass, wherein the thickness of indium-tin oxide film is 230 Å;

(2) a sensing window (2×2 mm2); and

(3) the condition of forming tin dioxide sensing film: the thickness of tin oxide sensing film is 2000A, which is formed via the sputtering tin dioxide using a tin dioxide target in a gas mixtures of Ar and O₂ (4:1) with the air pressure of 20 mtorr, the radio frequency power of 50 Watt, and the substrate temperature of 150° C.

(B) The condition of forming a tin dioxide/carbon/PET-extension ion biosensor:

(1) a carbon/PET substrate with a 2 mm diameter sensing window; and

(2) a tin dioxide sensing film: the thickness of tin oxide sensing film is 2000 Å, which is formed via sputtering tin dioxide using a tin dioxide target in a gas mixtures of Ar and O₂ (4:1) with the air pressure of 20 mtorr, the radio frequency power of 50 Watt and the substrate temperature of 150° C.

(C) The condition of forming an ammonium ion-selective electrode:

(1) mixing poly(vinyl chloride) carboxylated (PVC-COOH) 33%, bis(2-ethylhexyl) sebacate (DOS) 66%, and nonactin 1%, and then adding tetrahydroofuran (THF) 0.375 ml. Finally, mixing it using an ultrasound device;

(2) dropping 2 microliter of above-mentioned ammonium ion-selective on the tin dioxide sensing window; and

(3) putting it in a dark room for 12 to 24 hours to immobilize the ammonium ion-selective electrode.

(D) The condition of forming a potentiometric urea sensing film:

(1) diluting PVA-SbQ 120 mg/100 microliter (pH 7.0, phosphate solution 5 mmol/L), and mixing it with enzyme solution 10 mg/100 microliter (pH 7.0, phosphate solution 5 mmol/L). The ratio of volume is 1:1;

(2) dropping 1 microliter solution on the tin dioxide sensing window; and photo polymerization it via 4 Watt, 365 nm UV light for 20 minutes; and

(3) putting it in a dark room for 12 to 24 hours to immobilize the urea sensing film.

(E) The condition of forming a potentiometric creatinine sensing film:

(1) diluting PVA-SbQ 50 mg/100 microliter (pH 7.0, phosphate solution 5 mmol/L), and mixing it with enzyme solution 0.2 mg/ml (pH 7.0, phosphate solution 5 mmol/L). The ratio of volume is 1:1;

(2) dropping 1.0 microliter solution on the creatinine sensing window; and photo polymerization it via 4 Watt, 365 nm UV light for 20 minutes; and

(3) putting it in a dark room for 12 to 24 hours to immobilize the creatinine sensing film.

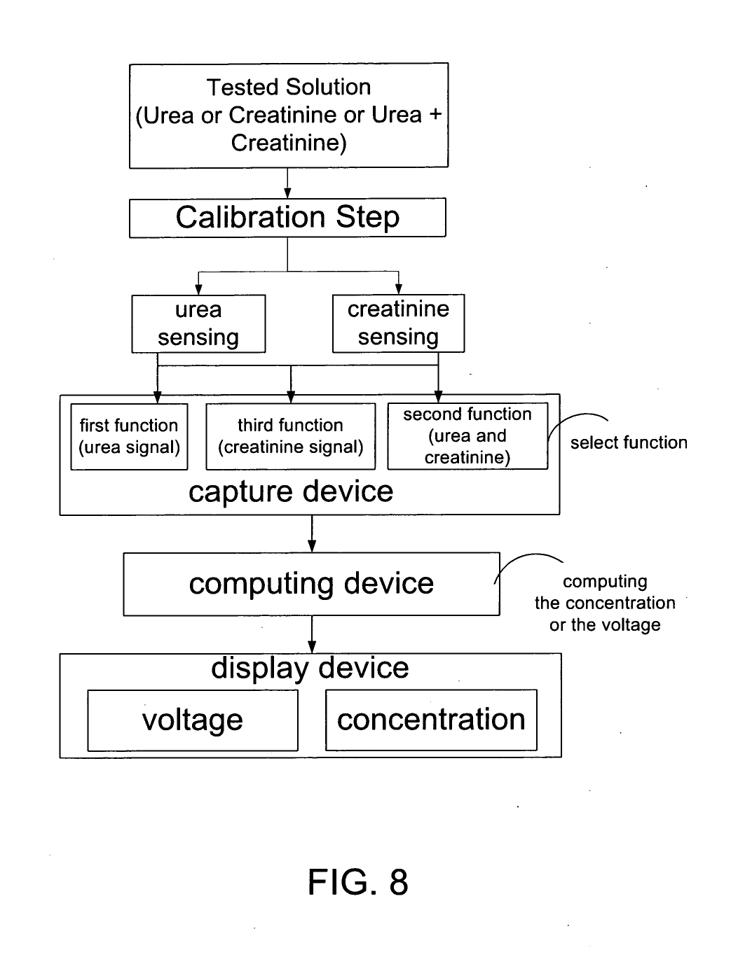

FIG. 8 shows the flow chart of the method for the potentiometric biosensor to detect the concentration and the voltage of the tested solution. A calibration step is taken first. Before the measurement, put at least two working electrode into a buffer solution and wait it to stabilize. Then, measure a reaction voltage as a reference voltage. Then, put at least two working electrodes into the tested solution, and a capture device records the reaction voltage. The capture device has three functional bottoms, including first function (urea signal), second function (urea and creatinine), and third function (creatinine signal). The concentration of urea or creatinine is calculated via a computing device, and displayed on display devices.

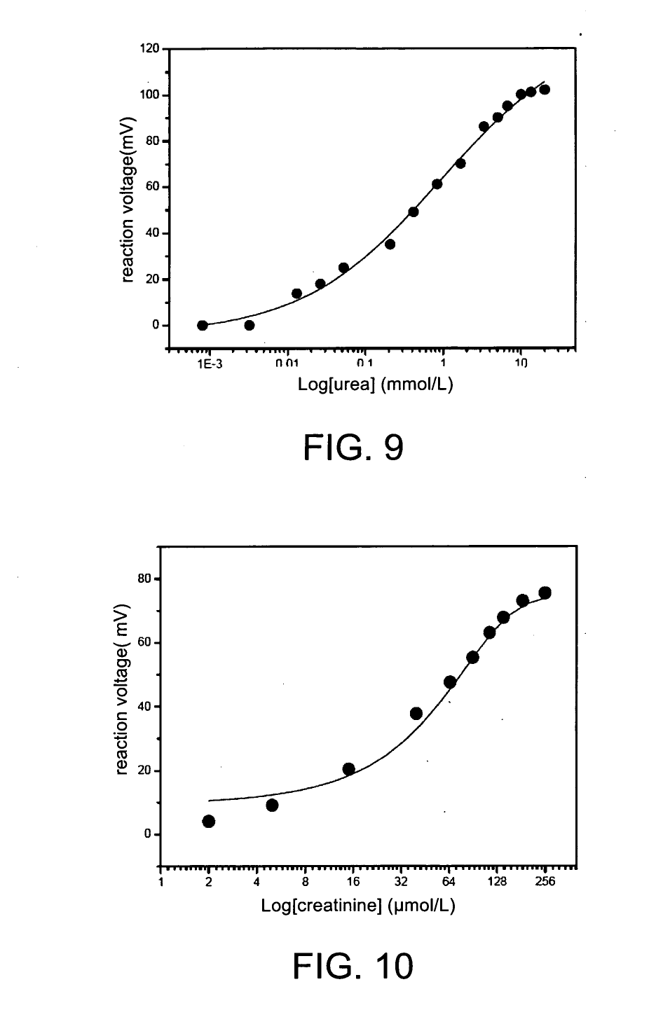

FIG. 9 shows a diagram of the reaction voltages versus the concentration of urea in the tested solution. The concentration is from 0.8 micromole per liter to 20 millimole per liter at pH 7.5. The urea measurement linear range of the urea sensing film is from 0.01 to 10 millimole per liter.

FIG. 10 shows a diagram of the reaction voltages versus the concentration of urea in the tested solution. The concentration is from 2 to 225 micromole per liter at pH 7.5. The creatinine measurement linear range of the creatinine sensing film is from 15 to 140 micromole per liter.

Obviously many modifications and variations are possible in light of the above teachings. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

What is claimed is:

1. A potentiometric biosensor, comprising:
a substrate;
at least two working electrodes formed on said substrate;
at least one counter electrode formed on said substrate;
an internal reference electrode formed on said substrate; and
a packaging structure, which separates the adjacent electrodes.

2. The potentiometric biosensor according to claim 1, wherein said potentiometric biosensor is used to detect the concentration of creatinine.

3. The potentiometric biosensor according to claim 1, wherein said potentiometric biosensor is used to detect the concentration of urea.

4. The potentiometric biosensor according to claim 1, wherein said substrate comprises one selected from the group consisting of the following: insulating glass, non-insulated indium-tin oxide glass, non-insulated tin dioxide glass, and polyethylene terephthalate (PET).

5. The potentiometric biosensor according to claim 1, wherein said working electrode comprising:
a first sensing layer formed on said substrate;
a first ion-selective layer formed on said first sensing layer; and
a first enzyme layer formed on said first ion-selective layer.

6. The potentiometric biosensor according to claim 5, wherein said first sensing layer is a non-insulated solid state ion, comprising one selected from the group consisting of the following: tin dioxide, titanium dioxide, and titanium nitride.

7. The potentiometric biosensor according to claim 5, wherein said first ion-selective layer is an ammonium ion-selective layer, comprising carboxylated polyvinylchloride (PVC-COOH).

8. The potentiometric biosensor according to claim 5, wherein said first enzyme layer comprises creatinine iminohydrolase (CIH).

9. The potentiometric biosensor according to claim 5, wherein said first enzyme layer comprises urease.

10. The potentiometric biosensor according to claim 5, wherein said working electrode further comprises a first conducting layer which lies between said substrate and said first sensing layer for outward transmission of a detection signal, and said first conducting layer possesses a low impedance as to enhance the transmission efficiency of said detection signal, and said first conducting layer comprises one selected from the group consisting of the following: copper, carbon, silver, aurum, silver chloride, and Indium tin oxides (ITO).

11. The potentiometric biosensor according to claim 10, wherein said working electrode further comprises a wire connected to said first conducting layer to facilitate the transmission of said detection signal, and said wire comprises one selected from the group consisting of the following: copper, carbon, silver, aurum, silver chloride, and Indium tin oxides (ITO).

12. The potentiometric biosensor according to claim 5, wherein said first enzyme layer is immobilized on said first ion-selective layer via entrapment method.

13. The potentiometric biosensor according to claim 12, wherein said first enzyme layer is immobilized on said first ion-selective layer via entrapment method by photocrosslinkable polyvinyl alcohol containing stilbazolium group (PVA-SbQ).

14. The potentiometric biosensor according to claim 10, wherein said first conducting layer comprises an exposed surface to electrically couple with the external world and for outward transmission of said detection signal.

15. The potentiometric biosensor according to claim 1, wherein said packaging structure is insulating epoxy resin.

16. The potentiometric biosensor according to claim 1, wherein said counter electrode is an ammonium ion-selective electrode, comprising:
a second conducting layer formed on said substrate;
a second sensing layer formed on said second conducting layer; and
a second ion-selective layer formed on said second sensing layer.

17. The potentiometric biosensor according to claim 1, wherein said second conducting layer comprises an exposed surface to electrically couple with the external world and for outward transmission of a detection signal, and said second conducting layer possesses a low impedance as to enhance the transmission efficiency of said detection signal, and said second conducting layer comprises one selected from the group consisting of the following: copper, carbon, silver, aurum, silver chloride, and Indium tin oxides (ITO).

18. The potentiometric biosensor according to claim 16, wherein said counter electrode further comprises a wire connected to said second conducting layer to facilitate the transmission of the detection signal, and said wire comprises one selected from the group consisting of the following: copper, carbon, silver, aurum, silver chloride, and Indium tin oxides (ITO).

19. The potentiometric biosensor according to claim 16, wherein said second sensing layer is a non-insulated solid state ion, comprising one selected from the group consisting of the following: tin dioxide, titanium dioxide, and titanium nitride.

20. The potentiometric biosensor according to claim 16, wherein said second ion-selective layer is an ammonium ion-selective layer, comprising carboxylated polyvinylchloride (PVC-COOH).

21. The potentiometric biosensor according to claim 1, wherein said internal reference electrode is a hydrogen ion-selective electrode, comprising:
a third conducting layer formed on said substrate; and
a third sensing layer formed on said third conducting layer.

22. The potentiometric biosensor according to claim 21, wherein said third conducting layer comprises an exposed surface to electrically couple with the external world and for outward transmission of a detection signal, and said third conducting layer possesses a low impedance as to enhance the transmission efficiency of said detection signal, and said third conducting layer comprises one selected from the group consisting of the following: copper, carbon, silver, aurum, silver chloride, and Indium tin oxides (ITO).

23. The potentiometric biosensor according to claim 21, wherein said internal reference electrode further comprises a wire connected to said third conducting layer to facilitate the transmission of said detection signal, and said wire comprises one selected from the group consisting of the following: copper, carbon, silver, aurum, silver chloride, and Indium tin oxides (ITO).

24. The potentiometric biosensor according to claim 21, wherein said third sensing layer is a non-insulated solid state ion, comprising one selected from the group consisting of the following: tin dioxide, titanium dioxide, and titanium nitride.

25. A method of forming a potentiometric biosensor, comprising:
providing a substrate;
forming an internal reference electrode on said substrate;
forming at least one counter electrode on said substrate;
forming at least two working electrodes on said substrate; and
forming a packaging structure to separate the adjacent electrodes.

26. The method of forming a potentiometric biosensor according to claim 25, further comprising: providing a wire connected to said at least two working electrodes, said at least one counter electrode, and said internal reference electrode, and the wire is for the transmission of a detection signal.

27. The method of forming a potentiometric biosensor according to claim 25, further comprising: forming an exposed surface on said at least two working electrodes, at least one counter electrode, and internal reference electrode to electrically couple with the external electrical devices and transmits of a detection signal.

28. The potentiometric biosensor according to claim 1, further comprising: providing a detection signal readout module electrically coupled with the potentiometric biosensor, and receiving said detection signals from said counter electrode, said internal reference electrode and said working electrodes.

29. A method of measuring a potentiometric biosensor, comprising:
measuring a reference voltage via putting at least two working electrode into a buffer solution;
amplifying a readout signal of at least two working electrodes using at least two instrumental amplifiers; and
measuring a reaction voltage via putting at least two working electrodes into a tested solution.

30. The method of measuring a potentiometric biosensor according to claim 29, wherein said at least two instrumental amplifiers electrically couples with a signal measurement module separately, and said signal measurement module measures the output signals from instrumental amplifiers to produce plural measured values, and each measured value corresponds to each output signal of the instrumental amplifier.
